(19) United States
(12) Patent Application Publication
(10) Pub. No.: US 2026/0270898 A1
(43) Pub. Date: Sep. 10, 2026

(54) SYSTEMS AND METHODS FOR RADIO RESOURCE MANAGEMENT MEASUREMENT PERIODICITY ENHANCEMENTS

(71) Applicant: APPLE INC., Cupertino, CA (US)

(72) Inventors: Jie Cui, San Jose, CA (US); Yang Tang, San Jose, CA (US); Qiming Li, Beijing (CN); Hong He, San Jose, CA (US); Dawei Zhang, Saratoga, CA (US); Xiang Chen, Campbell, CA (US); Haitong Sun, Cupertino, CA (US)

(21) Appl. No.: 19/167,586

(22) PCT Filed: May 10, 2023
(86) PCT No.: PCT/CN2023/093217

§ 371 Date: Sep. 22, 2025

(51) Int. Cl. H04W 56/00; H04W 24/10

(52) U.S. Cl. CPC H04W 56/001; H04W 24/10

(57) ABSTRACT

Systems and methods for radio resource management (RRM) measurement periodicity enhancements are disclosed herein. In some cases, a user equipment (UE) receives, from a network: a synchronization signal block (SSB)-based measurement timing configuration (SMTC) that indicates an SMTC periodicity for a target serving cell. The UE also receives an SSB periodicity of SSBs on the target serving cell. Then, the UE uses the SMTC periodicity and the SSB periodicity to determine a detection and measurement periodicity for the target serving cell, and proceeds to perform detection of the target serving cell and measurement of the target serving cell according to the detection and measurement periodicity. In some such cases, the UE uses the SSB periodicity value as the detection and measurement periodicity for the target serving cell. Cases where only one (or neither) of the SMTC periodicity and/or the SSB periodicity are provided to the UE are also explained.

### TECHNICAL FIELD

This application relates generally to wireless communication systems, including wireless communications systems performing measurements of target serving cells.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mm Wave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B together illustrate a description of existing periodicity assumptions that may exist with respect to a wireless communication system.

FIG. 2 illustrates ServingCellConfigCommon IE as may be used in some wireless communication systems.

FIG. 3 illustrates SSBs of a target serving cell that occur (are transmitted by the network for measurement by the UE) over time.

FIG. 4 illustrates a diagram showing one manner of performing cell detection and cell measurement of a target serving cell in cases where each of an SMTC for the target serving cell and an SSB periodicity for SSBs of the target serving cell are configured to the UE, according to embodiments herein.

FIG. 5 illustrates a diagram showing one manner of performing cell detection and cell measurement of a target serving cell in cases where each of an SMTC for the target serving cell and an SSB periodicity for SSBs of the target serving cell are configured to the UE, according to embodiments herein.

FIG. 6 illustrates a method of a UE, according to embodiments herein.

FIG. 7 illustrates a method of a UE, according to embodiments herein.

FIG. 8 illustrates a method of a UE, according to embodiments herein.

FIG. 9 illustrates a method of a UE, according to embodiments herein.

FIG. 10 illustrates a method of a UE, according to embodiments herein.

FIG. 11 illustrates a method of a UE, according to embodiments herein.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Various enhancements with respect to processes used in wireless communication systems for the measurement (e.g., radio resource management (RRM) measurement) of target serving cells may be considered.

For example, with respect to secondary cell (SCell) activation, it may be beneficial to use a synchronization signal block (SSB) periodicity (instead of, e.g., a SSB-based measurement timing configuration (SMTC) periodicity) in the context of measurements for SCell activation for an unknown cell (e.g., a cell for which an absolute receive (Rx) timing is not known to the UE). In some cases, such benefits may be considered for application in particular frequency ranges (e.g., for FR2).

It is noted that the use of the SSB periodicity (instead of, e.g., a SSB-based measurement timing configuration (SMTC) periodicity) may be beneficially applied not only in the context of measurements for SCell activation, but also within other measurement contexts that the UE may find itself in, such as, for example, handover and/or primary secondary cell (PSCell) addition (assuming that for such cases, the SSB periodicity of the target serving cell is provided to/known at the UE).

As will be described herein, the use of an SSB periodicity to control the timing of such measurements (and related cell detections) within a wireless communication system may involve more than swapping the SSB periodicity in place of an existing periodicity used for such purposes (e.g., an SMTC periodicity) that may be otherwise defined for use corresponding to such measurements.

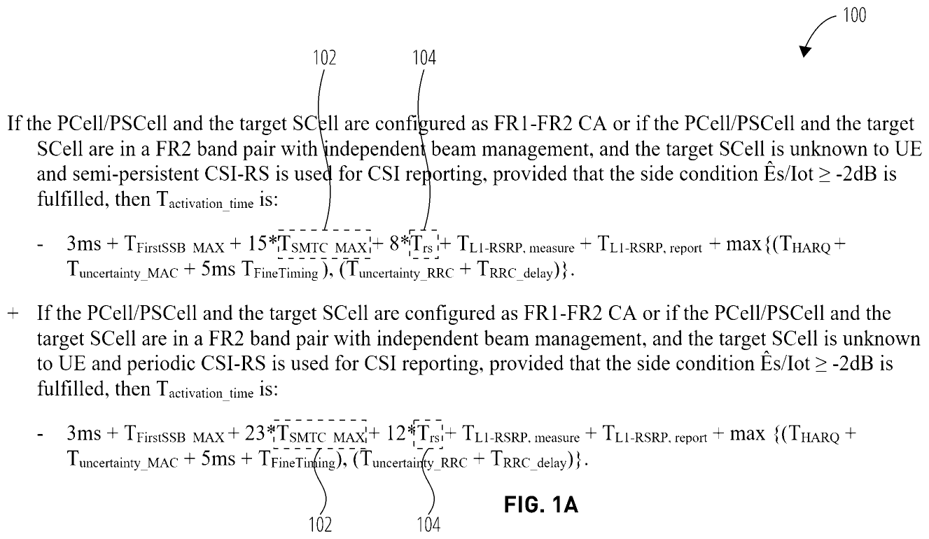

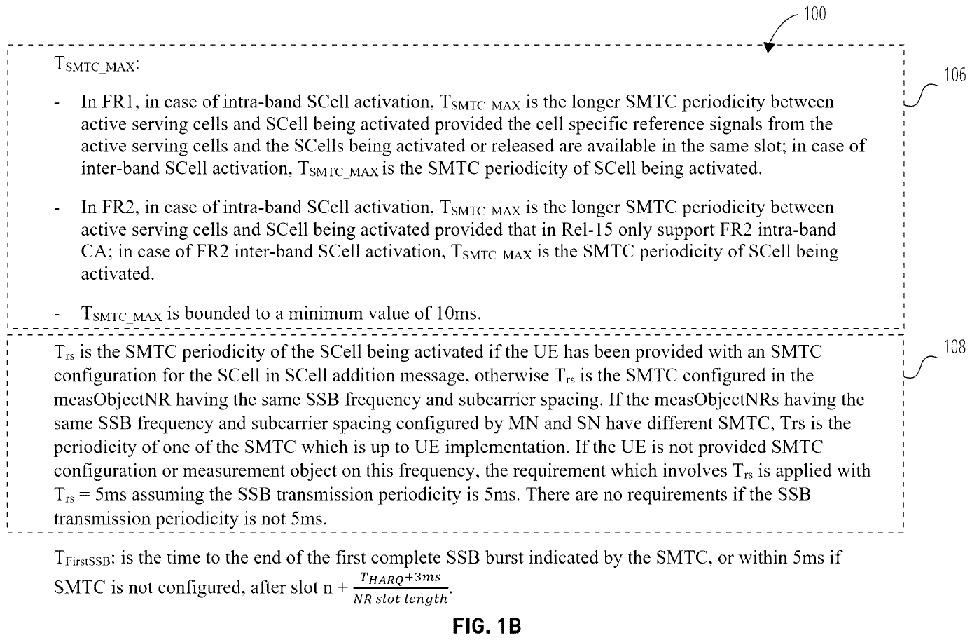

FIG. 1A and FIG. 1B together illustrate a description 100 of existing periodicity assumptions that may exist with respect to a wireless communication system. The description 100 may correspond to existing periodicity assumptions for an activation delay in the context of SCell activation that corresponds to a time used to measure a target SCell.

As may be seen in FIG. 1A, the activation delay is calculated with respect to a TSMTC_MAX parameter 102 and a Trs parameter 104. FIG. 1B proceeds to provide a first description 106 for the TSMTC_MAX parameter 102 and a second description 108 for the Trs parameter 104. As may be seen, each of the TSMTC_MAX parameter 102 and the Trs parameter 104 are determined with respect to, among other things, an SMTC periodicity of the target SCell. See 3GPP Technical Specification (TS) 38.133, section 8.3.2, version 18.1.0 (March 2023).

The description 100 represents one example of periodicity assumptions that are too complex for a mere substitution of a value for an SSB periodicity in for a value of an SMTC periodicity that applies in the context of SCell activation. Further it is noted that periodicity assumptions for contexts other than an SCell activation context as described with respect to FIG. 1A and FIG. 1B (e.g., handover, PSCell addition, etc.) may exhibit a similar complexity and/or dependency with respect to the use of particularized periodicity values other than SSB periodicity values.

Accordingly embodiments herein relate to an implementation of a generalized framework for using the SSB periodicity across many such measurement contexts.

It may be that, for various relevant operations with respect to a target serving cell (e.g., SCell activation, handover, PSCell addition, etc.), a network of the wireless communication system informs the UE of one or more aspects of a configuration of the target serving cell. One such aspect may be an SSB periodicity for SSBs on the target serving cell.

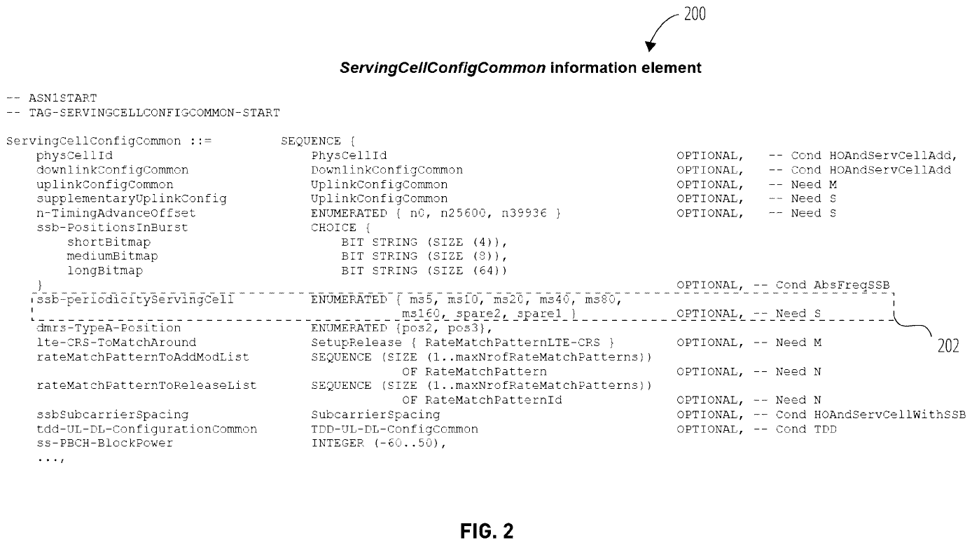

FIG. 2 illustrates ServingCellConfigCommon information element (IE) 200 as may be used in some wireless communication systems. The ServingCellConfigCommon IE 200 may be used to configure cell specific parameters of a target serving cell. In some cases, the ServingCellConfigCommon IE 200 contains parameters which a UE might otherwise acquire from SSBs, a master information block (MIB), and/or system information blocks (SIBs) when accessing the cell from a radio resource control (RRC) idle mode. Accordingly, by using the ServingCellConfigCommon IE 200, the network may provide this information to the UE in dedicated signaling (e.g., when configuring a UE to use the target serving cell as an SCell and/or as part of an additional cell group, such as a secondary cell group (SCG)). It also provides it for a target serving cell that is a special cell (SpCell) (e.g., of a master cell group (MCG) or an SCG) upon reconfiguration with synchronization.

As illustrated, the ServingCellConfigCommon IE 200 may include an ssb-periodicityServingCell IE 202 that informs the UE of the SSB periodicity for the target serving cell (e.g., in milliseconds (ms)). In some cases, if the ServingCellConfigCommon IE 200 is missing the ssb-periodicityServingCell IE 202, the UE will assume the value of a 5 ms for the SSB periodicity for at least some contexts.

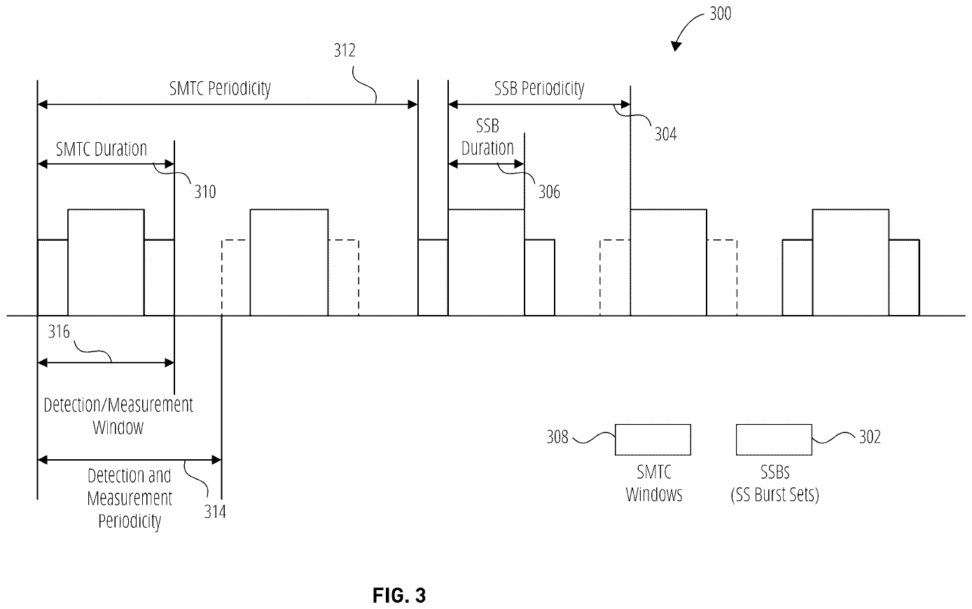

Discussion herein relates to embodiments in which a UE may perform detection and measurement of a target serving cell according to an SSB periodicity (e.g., in place of some other periodicity, such as an SMTC periodicity). FIG. 3 illustrates a diagram 300 showing various elements that may be referred to in descriptions herein with respect to such uses of an SSB periodicity.

FIG. 3 illustrates SSBs 302 of a target serving cell that occur (are transmitted by the network for measurement by the UE) over time. As illustrated, the SSBs 302 may be transmitted in synchronization signal (SS) burst set groupings that occur according to an SSB periodicity 304. Each such SS burst set is of an SSB duration 306, as illustrated.

FIG. 3 further illustrates SMTC windows 308 that may be understood at a UE according to an SMTC for the target serving cell that has been provided to the UE. As illustrated, the SMTC windows 308 may be understood to be of an SMTC duration 310 and occur according to an SMTC periodicity 312, values for each of which may be provided to the UE in the SMTC for the serving cell as received from the network. Note that dotted boxes at the locations of some of the SSBs 302 indicate locations where SMTC windows 308 would otherwise be located with respect to the corresponding SS burst, except that they are not present due to the application of the SMTC periodicity 312.

FIG. 3 further illustrates examples of a detection and measurement periodicity 314 and a detection and/or measurement window 316 that may be used according to some applications of various embodiments herein.

A detection and measurement periodicity 314 used by a UE may be a periodicity according to which the UE performs cell detection for the target serving cell is performed and, (once the cell is detected), a periodicity according to which cell measurement of the target serving cell is performed (e.g., based on the SS bursts of the SSBs 302). Note that while the particular example shown in FIG. 3 illustrates a detection and measurement periodicity 314 that runs between locations for SMTC windows (whether these be the actually used SMTC windows 308 or the non-used locations per the SMTC periodicity 312 corresponding to some SS bursts as illustrated), in some circumstances a detection and measurement periodicity may be instead applied as between SS burst sets of the SSBs 302 during the cell measurement process, is described in further detail herein.

As is discussed in further detail herein, the detection and measurement periodicity 314 may be different than/independent from an SMTC periodicity 312 that is configured for the target serving cell.

The detection and/or measurement window 316 represents one example of a window that may be used for detection of the target serving cell and/or measurement of the target serving cell, according to the detection and measurement periodicity 314. Note that while the particular example shown in FIG. 3 illustrates a detection and/or measurement window 316 of one single illustrated duration, it is contemplated that in at least some cases, a detection window (used for cell detection of the target serving cell) and a measurement window (used for cell measurement on the target serving cell) may be of different durations.

A detection and/or measurement window 316 may be of a duration that is different than/independent from the SMTC duration 310 associated with the SMTC windows 308.

Various scenarios with respect to embodiments performing cell detection and cell measurement of a target serving cell according to an SSB periodicity are discussed herein.

A first such scenario relates to the manner of performing cell detection and cell measurement of the target serving cell in cases where each of an SMTC for the target serving cell and an SSB periodicity for SSBs of the target serving cell are configured to the UE. Example considerations for such cases include considerations for the arrangement of detection and/or measurement windows, considerations for whether a lower boundary value for a detection and measurement periodicity should be used in some circumstances, etc.

A second such scenario relates to the manner of performing cell detection and cell measurement of the target serving cell when an SSB periodicity for SSBs of the target serving cell is configured to the UE, but an SMTC for the target serving cell is not configured to the UE. Example considerations for such cases include considerations for the arrangement of detection and/or measurement windows, considerations for whether a lower boundary value (or an assumed SSB periodicity of 5 ms) should be used for a detection and measurement periodicity in some circumstances, etc.

A third such scenario relates to the manner of performing cell detection and cell measurement of the target serving cell when an SMTC for the target serving cell is configured to the UE, but an SSB periodicity for SSBs of the target serving cell is not configured to the UE. Example considerations for such cases include considerations for the arrangement of detection and/or measurement windows, considerations for whether a lower boundary value (or an assumed SSB periodicity of 5 ms) should be used for a detection and measurement periodicity in some circumstances, etc.

A fourth such scenario relates to the manner of performing cell detection and cell measurement of the target serving cell when neither an SMTC for the target serving cell nor an SSB periodicity for SSBs of the target serving cell is configured to the UE. Example considerations for such cases include considerations for the arrangement of detection and/or measurement windows, considerations for whether a lower boundary value (or an assumed SSB periodicity of 5 ms) should be used for a detection and measurement periodicity in some circumstances, etc.

It should be noted that for purposes of this disclosure, an SMTC for the target serving cell may be either an SMTC for a carrier of the target serving cell that is configured to the UE, or an SMTC of a different carrier/measurement object (MO) that uses a same SSB frequency and a same subcarrier spacing as the target serving cell are used on the target serving cell that is configured to the UE (as the UE can apply this SMTC with respect to the target serving cell).

In may be that, in some embodiments, an SSB periodicity is configured to the UE through the provision of a ServingCellConfigCommon IE having an ssb-periodicityServingCell IE, in the manner described herein.

### First Scenario

A first scenario relates to the manner of performing cell detection and cell measurement of the target serving cell in cases where each of an SMTC for the target serving cell and an SSB periodicity for SSBs of the target serving cell are configured to the UE.

In some cases under the first scenario, the UE may use a detection and measurement periodicity that is equal to a minimum of the SMTC periodicity and the SSB periodicity. Accordingly, in such cases, the UE performs cell detection and cell measurement with respect to SS bursts of SSBs on the target serving cell according to this value.

In some cases under the first scenario, the UE may use a detection and measurement periodicity that is equal to a minimum of the SMTC periodicity and the SSB periodicity if that value is greater than or equal to a lower boundary value for the detection and measurement periodicity. Otherwise, the detection and measurement periodicity may be set instead to the lower boundary value for the detection and measurement periodicity. The UE then performs cell detection and cell measurement with respect to SS bursts of SSBs on the target serving cell according to the determined value.

In some cases under the first scenario, the UE may use the SSB periodicity as the detection and measurement periodicity if the SSB periodicity is greater than or equal to a lower boundary value for the detection and measurement periodicity. Otherwise, the detection and measurement periodicity may be set instead to the lower boundary value for the detection and measurement periodicity. The UE then performs cell detection and cell measurement with respect to SS bursts of SSBs on the target serving cell according to the determined value.

In the above cases, a lower boundary value for the detection and measurement periodicity may be 10 ms in some embodiments. In some cases, a lower boundary value for the detection and measurement periodicity may be pre-configured to the UE. In some cases, a lower boundary value for the detection and measurement periodicity may be configured to the UE by the network.

Under the first scenario, the UE may determine a duration of a detection window and a duration of a measurement window according to various cases.

In some cases under the first scenario, the duration for each of a detection window and a measurement window may be equal to an SMTC duration (even though the detection and measurement periodicity may not be the same as an SMTC periodicity).

In other cases, the duration of a detection window may be equal to an SMTC duration (even though the detection and measurement periodicity may not be the same as an SMTC periodicity). However, it may be that the duration of a measurement window is instead equal to an SSB duration. The use of the detection window that is equal to an SMTC duration may provide the UE with the sufficient timing slack to successfully identify SSBs on the target serving cell, while the use of a measurement window duration that is equal to an SSB duration may reflect the understanding that once the target serving cell is properly detected and the locations in time of the SSBs/the SS burst sets to be used for measurement are accordingly known, measurement may need be enabled only during periods where SSBs are expected (e.g., to save power). Note that the duration of the SSBs to be measured (the duration of an SS burst set) may be determined at the UE based on configuration information for the SSBs that has been provided to the UE.

It will also be understood that in such cases where the duration of the measurement window is enabled only during SS burst sets of the measured SSBs, the detection and measurement periodicity, for purposes of these measurements, is considered to run between these SS burst sets.

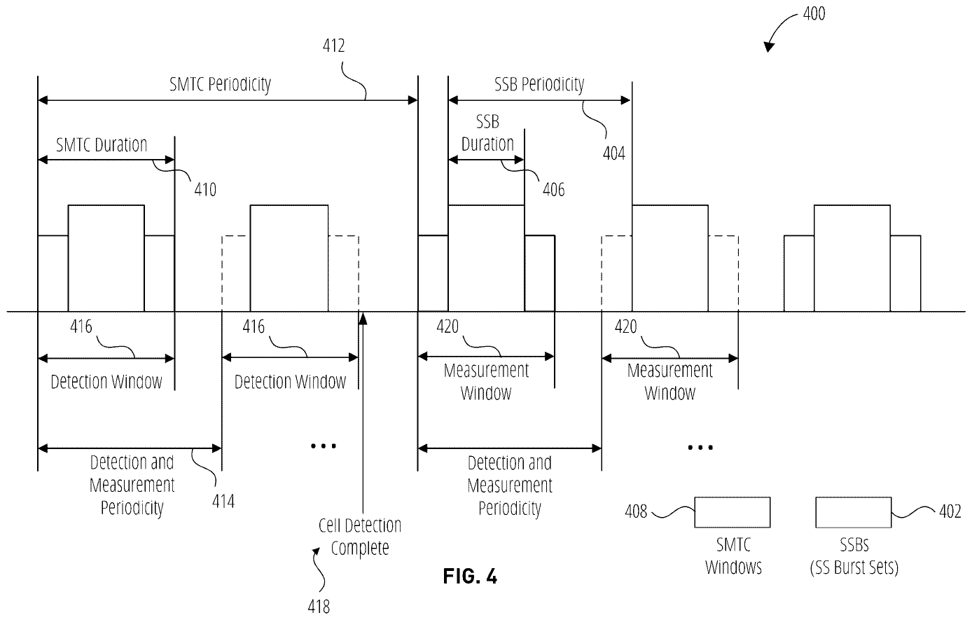

FIG. 4 illustrates a diagram 400 showing one manner of performing cell detection and cell measurement of a target serving cell in cases where each of an SMTC for the target serving cell and an SSB periodicity for SSBs of the target serving cell are configured to the UE, according to embodiments herein. As illustrated, the SSBs 402 of a target serving cell are transmitted by the network for measurement by the UE over time in SS burst set groupings that occur according to an SSB periodicity 404 and that are of an SSB duration 406. Further, as illustrated, SMTC windows 408 may be understood at a UE according to an SMTC for the target serving cell that has been provided to the UE, and may be of an SMTC duration 410 and occur according to an SMTC periodicity 412.

FIG. 4 corresponds to a case were the UE has determined that a detection and measurement periodicity 414 that will be used for cell detection and cell measurement is the same duration as an SSB periodicity 404 (as illustrated). Accordingly, the UE performs cell detection using detection windows 416 that occur according to the detection and measurement periodicity 414. Note that the detection windows 416 have a duration that is equal to the SMTC duration 410.

Once the UE completes 418 cell detection, the UE proceeds to perform cell measurement using measurement windows 420 that occur according to the detection and measurement periodicity 414. Note that in the diagram 400 illustrates a case where a duration of the measurement windows 420 is equal to the SMTC duration 410.

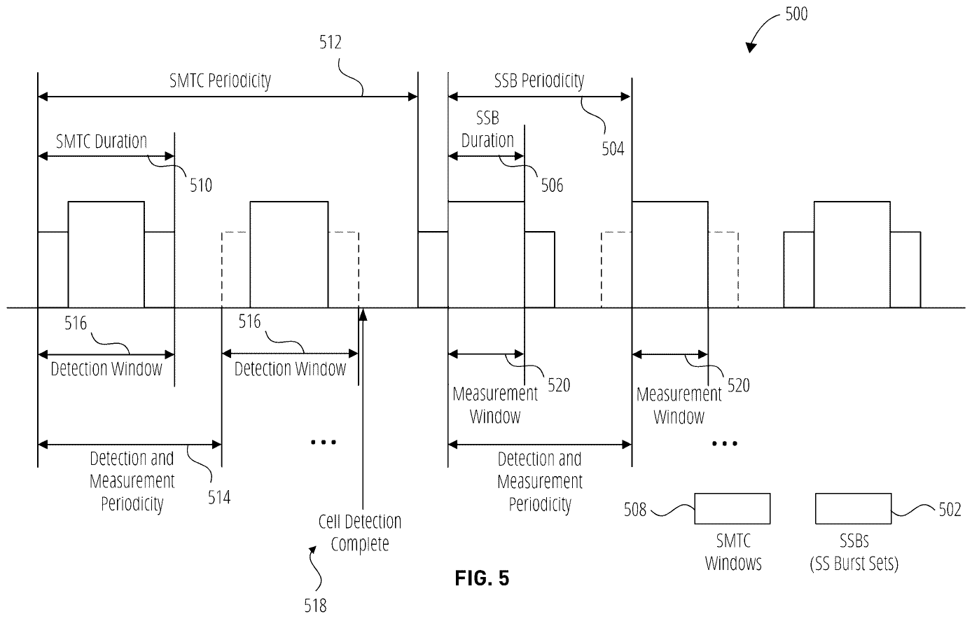

FIG. 5 illustrates a diagram 500 showing one manner of performing cell detection and cell measurement of a target serving cell in cases where each of an SMTC for the target serving cell and an SSB periodicity for SSBs of the target serving cell are configured to the UE, according to embodiments herein. As illustrated, the SSBs 502 of a target serving cell are transmitted by the network for measurement by the UE over time in SS burst set groupings that occur according to an SSB periodicity 504 and that are of an SSB duration 506. Further, as illustrated, SMTC windows 508 may be understood at a UE according to an SMTC for the target serving cell that has been provided to the UE, and may be of an SMTC duration 510 and occur according to an SMTC periodicity 512.

FIG. 5 corresponds to a case were the UE has determined that a detection and measurement periodicity 514 that will be used for cell detection and cell measurement is the same duration as an SSB periodicity 504 (as illustrated). Accordingly, the UE performs cell detection using detection windows 516 that occur according to the detection and measurement periodicity 514. Note that the detection windows 516 have a duration that is equal to the SMTC duration 510.

Once the UE completes 518 cell detection, the UE proceeds to perform cell measurement using measurement windows 520 that occur according to the detection and measurement periodicity 514. Note that the diagram 500 illustrates a case where a duration of the measurement windows 420 is equal to the SSB duration 506. Further, note that because the measurement windows 520 begin at the SS burst sets of the SSBs 502, the detection and measurement periodicity 514 is measured from the beginning of the SS burst sets (rather than from locations for the SMTC windows 508/the non-used locations corresponding some SS bursts) once the UE begins using the measurement windows 520.

### Second Scenario

A second scenario relates to the manner of performing cell detection and cell measurement of the target serving cell when an SSB periodicity for SSBs of the target serving cell is configured to the UE, but an SMTC for the target serving cell is not configured to the UE.

In some cases under the second scenario, the UE may use a fixed value (that is provided in, for example, a specification for the wireless communication system) to determine a detection and measurement periodicity. In some such cases, the fixed value may be, for example, 5 ms.

In some cases under the second scenario, the UE may set the detection and measurement periodicity to a lower boundary value for the detection and measurement periodicity. This lower boundary value may be pre-configured to the UE, or may be configured to the UE by the network. In some such cases, the lower boundary value may be, for example, 10 ms.

In some cases under the second scenario, the UE may use the SSB periodicity as the detection and measurement periodicity (e.g., as long as an SMTC for the target serving cell remains unconfigured).

In some cases under the second scenario, the UE may use the SSB periodicity as the detection and measurement periodicity if the SSB periodicity is greater than or equal to a lower boundary value for the detection and measurement periodicity. Otherwise, the detection and measurement periodicity may be set instead to the lower boundary value for the detection and measurement periodicity. The UE then performs cell detection and cell measurement with respect to SS bursts of SSBs on the target serving cell according to the determined value. In some such cases, the lower boundary value may be, for example, 10 ms.

Under the second scenario, the UE may determine the duration for a cell detection window and/or a cell measurement window as a fixed value (e.g., 5 ms) and may further use a fixed time offset for this window (e.g., a zero offset).

### Third Scenario

A third scenario relates to the manner of performing cell detection and cell measurement of the target serving cell when an SMTC for the target serving cell is configured to the UE, but an SSB periodicity for SSBs of the target serving cell is not configured to the UE.

In some cases under the third scenario, the UE may use a fixed value (that is provided in, for example, a specification for the wireless communication system) to determine a detection and measurement periodicity. In some such cases, the fixed value may be, for example, 5 ms.

In some cases under the third scenario, the duration for each of a detection window and a measurement window may be equal to an SMTC duration from the SMTC.

### Fourth Scenario

A fourth scenario relates to the manner of performing cell detection and measurement of the target serving cell when neither an SMTC for the target serving cell nor an SSB periodicity for SSBs of the target serving cell is configured to the UE.

In some cases under the fourth scenario, the UE may use a fixed value (that is provided in, for example, a specification for the wireless communication system) to determine a detection and measurement periodicity. In some such cases, the fixed value may be, for example, 5 ms.

In some cases under the fourth scenario, the UE may set the detection and measurement periodicity to a lower boundary value for the detection and measurement periodicity. This lower boundary value may be pre-configured to the UE, or may be configured to the UE by the network. In some such cases, the lower boundary value may be, for example, 10 ms.

Under the fourth scenario, the UE may determine the duration for a cell detection window and/or a cell measurement window as a fixed value (e.g., 5ms) and may further use a fixed time offset for this window (e.g., a zero offset).

It may be noted that the use of a fixed value and the use of a lower boundary value as described in various embodiments herein have different physical meanings. For example, in some cases, a lower boundary value is independently defined or signaled from the network, while a fixed value is a default value (e.g., pre-defined per a specification for the wireless communication system). One or both of these two parameters may be configured/specified for and/or be applicable to various scenarios, as is described herein.

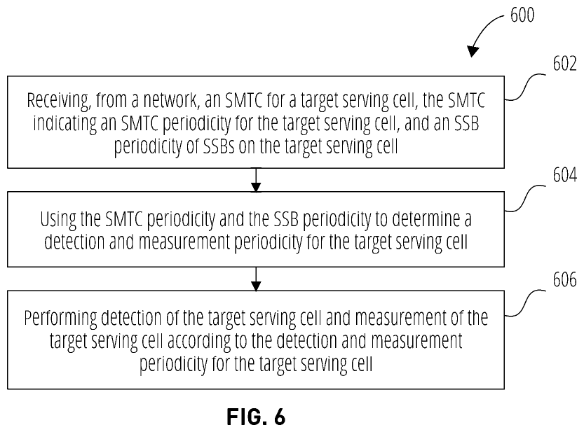

FIG. 6 illustrates a method 600 of a UE, according to embodiments herein. The method 600 includes receiving 602, from a network, an SMTC for a target serving cell, the SMTC indicating an SMTC periodicity for the target serving cell, and an SSB periodicity of SSBs on the target serving cell. The method 600 further includes using 604 the SMTC periodicity and the SSB periodicity to determine a detection and measurement periodicity for the target serving cell. The method 600 further includes performing 606 detection of the target serving cell and measurement of the target serving cell according to the detection and measurement periodicity for the target serving cell.

In some embodiments of the method 600, using the SMTC periodicity and the SSB periodicity to determine the detection and measurement periodicity for the target serving cell comprises: determining a minimum of the SMTC periodicity and the SSB periodicity; and setting the detection and measurement periodicity for the target serving cell equal to the minimum of the SMTC periodicity and the SSB periodicity.

In some embodiments of the method 600, using the SMTC periodicity and the SSB periodicity to determine the detection and measurement periodicity for the target serving cell comprises: determining a minimum of the SMTC periodicity and the SSB periodicity; comparing the minimum of the SMTC periodicity and the SSB periodicity to a lower boundary value for the detection and measurement periodicity; and performing one of: setting the detection and measurement periodicity for the target serving cell equal to the minimum of the SMTC periodicity and the SSB periodicity when the minimum of the SMTC periodicity and the SSB periodicity is greater than or equal to the lower boundary value; and setting the detection and measurement periodicity for the target serving cell equal to the lower boundary value when the minimum of the SMTC periodicity and the SSB periodicity is less than the lower boundary value. In some such embodiments, the method 600 further includes receiving, from the network, the lower boundary value for the detection and measurement periodicity.

In some embodiments of the method 600, the detection of the target serving cell and the measurement of the target serving cell are performed using one or more detection and measurement windows of a detection and measurement window duration that is equal to an SMTC duration indicated by the SMTC.

In some embodiments of the method 600, the detection of the target serving cell is performed using one or more detection windows of a detection window duration that is equal to an SMTC duration indicated by the SMTC and the measurement of the target serving cell is performed using one or more measurement windows of a measurement window duration that is equal to an SSB duration for the SSBs on the target serving cell.

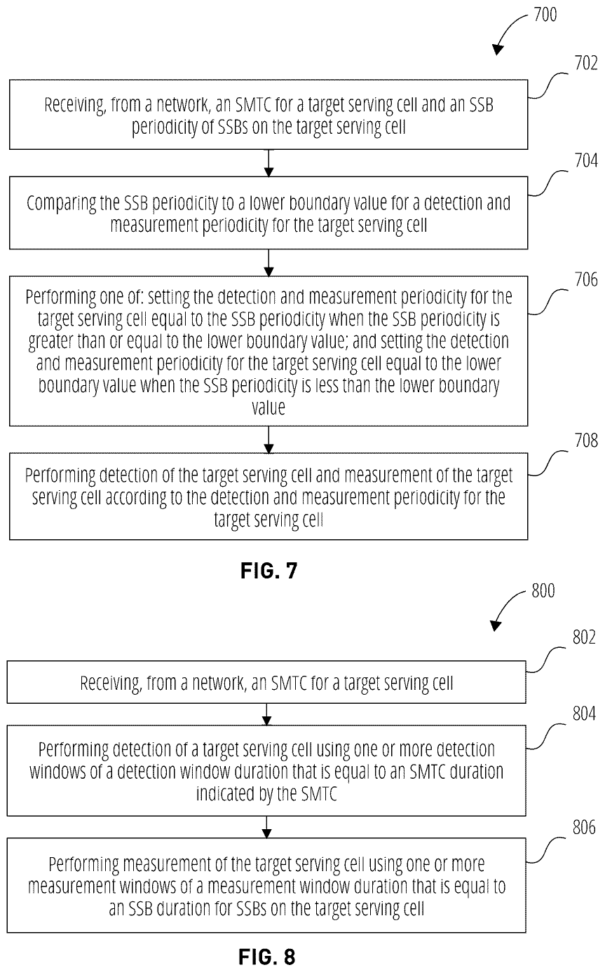

FIG. 7 illustrates a method 700 of a UE, according to embodiments herein. The method 700 includes receiving 702, from a network, an SMTC for a target serving cell and an SSB periodicity of SSBs on the target serving cell. The method 700 further includes comparing 704 the SSB periodicity to a lower boundary value for a detection and measurement periodicity for the target serving cell. The method 700 further includes performing 706 one of: setting the detection and measurement periodicity for the target serving cell equal to the SSB periodicity when the SSB periodicity is greater than or equal to the lower boundary value; and setting the detection and measurement periodicity for the target serving cell equal to the lower boundary value when the SSB periodicity is less than the lower boundary value. The method 700 further includes performing 708 detection of the target serving cell and measurement of the target serving cell according to the detection and measurement periodicity for the target serving cell.

In some embodiments of the method 700, the detection of the target serving cell and the measurement of the target serving cell are performed using one or more detection and measurement windows of a detection and measurement window duration that is equal to an SMTC duration indicated by the SMTC.

In some embodiments of the method 700, the detection of the target serving cell is performed using one or more detection windows of a detection window duration that is equal to an SMTC duration indicated by the SMTC and the measurement of the target serving cell is performed using one or more measurement windows of a measurement window duration that is equal to an SSB duration for the SSBs on the target serving cell.

FIG. 8 illustrates a method 800 of a UE, according to embodiments herein. The method 800 includes receiving 802, from a network, an SMTC for a target serving cell. The method 800 further includes performing 804 detection of a target serving cell using one or more detection windows of a detection window duration that is equal to an SMTC duration indicated by the SMTC. The method 800 further includes performing 806 measurement of the target serving cell using one or more measurement windows of a measurement window duration that is equal to an SSB duration for SSBs on the target serving cell.

In some embodiments, the method 800 further includes using an SMTC periodicity indicated by the SMTC and an SSB periodicity of the SSBs to determine a detection and measurement periodicity for the target serving cell; wherein the detection of the target serving cell and measurement of the target serving cell are performed according to the detection and measurement periodicity for the target serving cell.

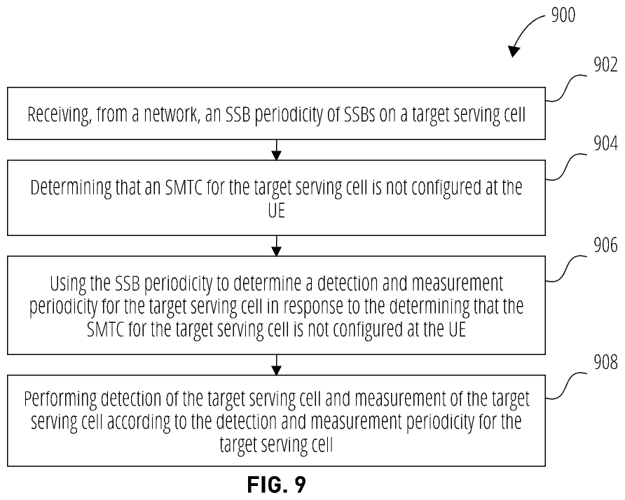

FIG. 9 illustrates a method 900 of a UE, according to embodiments herein. The method 900 includes receiving 902, from a network, an SSB periodicity of SSBs on a target serving cell. The method 900 further includes determining 904 that an SMTC for the target serving cell is not configured at the UE. The method 900 further includes using 906 the SSB periodicity to determine a detection and measurement periodicity for the target serving cell in response to the determining that the SMTC for the target serving cell is not configured at the UE. The method 900 further includes performing 908 detection of the target serving cell and measurement of the target serving cell according to the detection and measurement periodicity for the target serving cell.

In some embodiments of the method 900, using the SSB periodicity to determine the detection and measurement periodicity for the target serving cell comprises: comparing the SSB periodicity to a lower boundary value for the detection and measurement periodicity for the target serving cell and performing one of: setting the detection and measurement periodicity for the target serving cell equal to the SSB periodicity when the SSB periodicity is greater than or equal to the lower boundary value; and setting the detection and measurement periodicity for the target serving cell equal to the lower boundary value when the SSB periodicity is less than the lower boundary value.

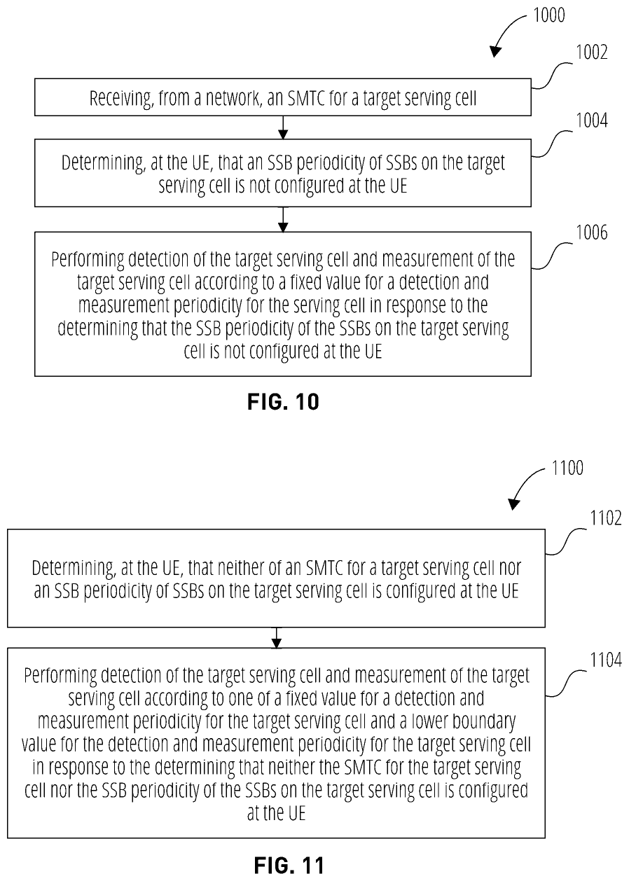

FIG. 10 illustrates a method 1000 of a UE, according to embodiments herein.

The method 1000 includes receiving 1002, from a network, an SMTC for a target serving cell. The method 1000 further includes determining 1004, at the UE, that an SSB periodicity of SSBs on the target serving cell is not configured at the UE. The method 1000 further includes performing 1006 detection of the target serving cell and measurement of the target serving cell according to a fixed value for a detection and measurement periodicity for the serving cell in response to the determining that the SSB periodicity of the SSBs on the target serving cell is not configured at the UE.

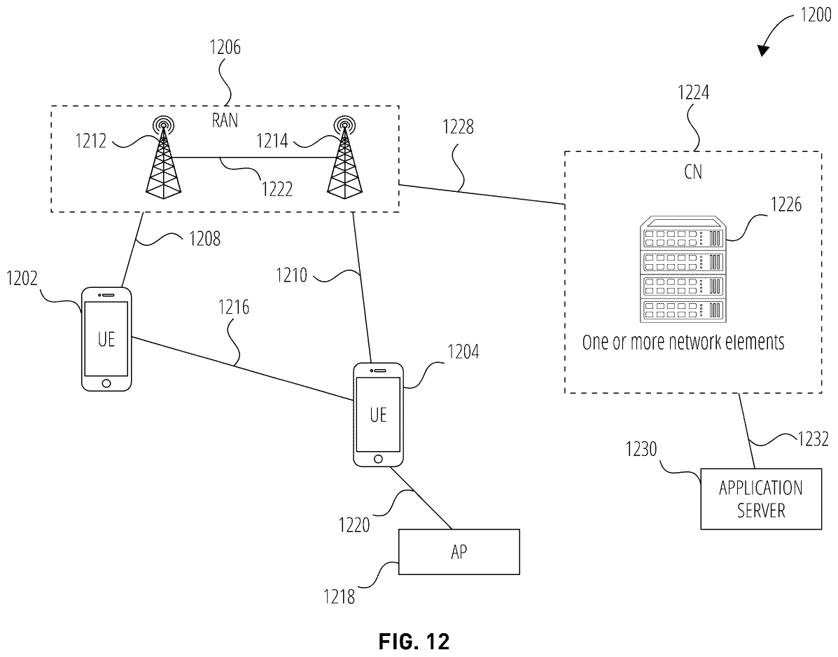

FIG. 11 illustrates a method 1100 of a UE, according to embodiments herein.

The method 1100 includes determining 1102, at the UE, that neither of an SMTC for a target serving cell nor an SSB periodicity of SSBs on the target serving cell is configured at the UE. The method 1100 further includes performing 1104 detection of the target serving cell and measurement of the target serving cell according to one of a fixed value for a detection and measurement periodicity for the target serving cell and a lower boundary value for the detection and measurement periodicity for the target serving cell in response to the determining that neither the SMTC for the target serving cell nor the SSB periodicity of the SSBs on the target serving cell is configured at the UE.

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations (such as base station 1212 and base station 1214) that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

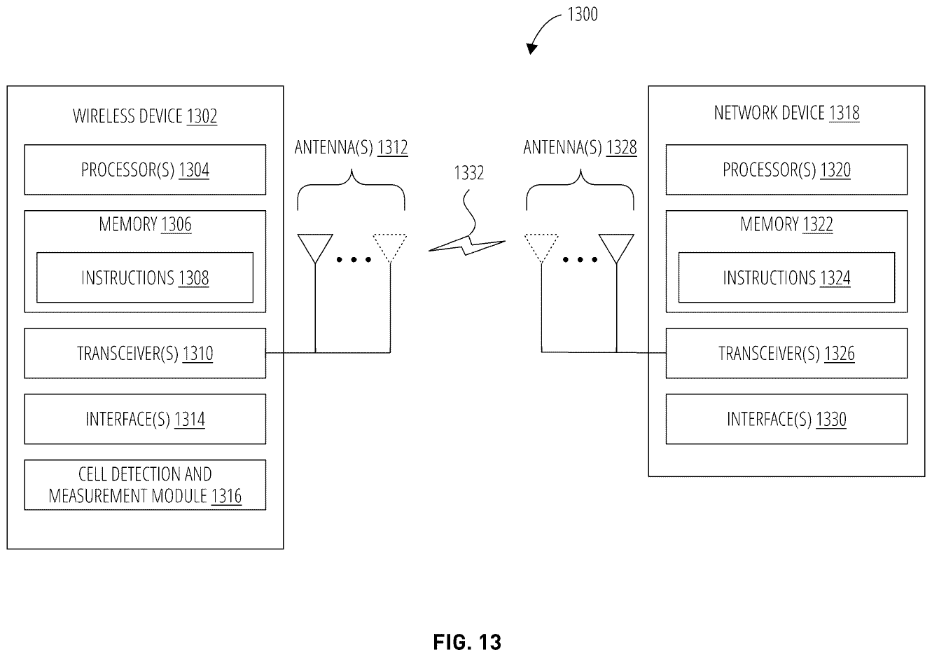

FIG. 13 illustrates a system 1300 for performing signaling 1332 between a wireless device 1302 and a network device 1318, according to embodiments disclosed herein. The system 1300 may be a portion of a wireless communications system as herein described. The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter circuitry and/or receiver circuitry that use the antenna(s) 1312 of the wireless device 1302 to facilitate signaling (e.g., the signaling 1332) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include a cell detection and measurement module 1316. The cell detection and measurement module 1316 may be implemented via hardware, software, or combinations thereof. For example, the cell detection and measurement module 1316 may be implemented as a processor, circuit, and/or instructions 1308 stored in the memory 1306 and executed by the processor(s) 1304. In some examples, the cell detection and measurement module 1316 may be integrated within the processor(s) 1304 and/or the transceiver(s) 1310. For example, the cell detection and measurement module 1316 may be implemented by a combination of software components (e.g., executed by a DSP or a general processor) and hardware components (e.g., logic gates and circuitry) within the processor(s) 1304 or the transceiver(s) 1310.

The cell detection and measurement module 1316 may be used for various aspects of the present disclosure, for example, aspects of FIG. 1A through FIG. 11. The cell detection and measurement module 1316 may be configured to, for example, determine and utilize a detection and measurement periodicity, determine and utilize a detection window according to the detection and measurement periodicity, and/or determine and utilize a measurement window according to the detection and measurement periodicity, in the manners described herein.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter circuitry and/or receiver circuitry that use the antenna(s) 1328 of the network device 1318 to facilitate signaling (e.g., the signaling 1332) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

Embodiments contemplated herein include an apparatus comprising means to perform one or more elements of any of the method 600, the method 700, the method 800, the method 900, the method 1000, and/or the method 1100. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 600, the method 700, the method 800, the method 900, the method 1000, and/or the method 1100. This non-transitory computer-readable media may be, for example, a memory of a UE (such as a memory 1306 of a wireless device 1302 that is a UE, as described herein).

Embodiments contemplated herein include an apparatus comprising logic, modules, or circuitry to perform one or more elements of any of the method 600, the method 700, the method 800, the method 900, the method 1000, and/or the method 1100. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 600, the method 700, the method 800, the method 900, the method 1000, and/or the method 1100. This apparatus may be, for example, an apparatus of a UE (such as a wireless device 1302 that is a UE, as described herein).

Embodiments contemplated herein include a signal as described in or related to one or more elements of any of the method 600, the method 700, the method 800, the method 900, the method 1000, and/or the method 1100.

Embodiments contemplated herein include a computer program or computer program product comprising instructions, wherein execution of the program by a processor is to cause the processor to carry out one or more elements of any of the method 600, the method 700, the method 800, the method 900, the method 1000, and/or the method 1100. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus of a user equipment (UE), comprising:
one or more processors; and
a memory storing instructions that, when executed by the one or more processors, configure the UE to:
receive, from a network:
a synchronization signal block (SSB)-based measurement time configuration (SMTC) for a target serving cell, the SMTC indicating an SMTC periodicity for the target serving cell; and
an SSB periodicity of SSBs on the target serving cell;
use the SMTC periodicity and the SSB periodicity to determine a detection and measurement periodicity for the target serving cell; and
perform detection of the target serving cell and measurement of the target serving cell according to the detection and measurement periodicity for the target serving cell.

2. The apparatus of claim 1, wherein the use of the SMTC periodicity and the SSB periodicity to determine the detection and measurement periodicity for the target serving cell comprises:
determining a minimum of the SMTC periodicity and the SSB periodicity; and
setting the detection and measurement periodicity for the target serving cell equal to the minimum of the SMTC periodicity and the SSB periodicity.

3. The apparatus of claim 1, wherein the use of the SMTC periodicity and the SSB periodicity to determine the detection and measurement periodicity for the target serving cell comprises:
determining a minimum of the SMTC periodicity and the SSB periodicity;
comparing the minimum of the SMTC periodicity and the SSB periodicity to a lower boundary value for the detection and measurement periodicity; and
performing one of:
setting the detection and measurement periodicity for the target serving cell equal to the minimum of the SMTC periodicity and the SSB periodicity when the minimum of the SMTC periodicity and the SSB periodicity is greater than or equal to the lower boundary value; and
setting the detection and measurement periodicity for the target serving cell equal to the lower boundary value when the minimum of the SMTC periodicity and the SSB periodicity is less than the lower boundary value.

4. The apparatus of claim 3, wherein the instructions, when executed by the one or more processors, further configure the UE to receive, from the network, the lower boundary value for the detection and measurement periodicity.

5. The apparatus of claim 1, wherein the detection of the target serving cell and the measurement of the target serving cell are performed using one or more detection and measurement windows of a detection and measurement window duration that is equal to an SMTC duration indicated by the SMTC.

6. The apparatus of claim 1, wherein:
the detection of the target serving cell is performed using one or more detection windows of a detection window duration that is equal to an SMTC duration indicated by the SMTC; and
the measurement of the target serving cell is performed using one or more measurement windows of a measurement window duration that is equal to an SSB duration for the SSBs on the target serving cell.

7. A method of a user equipment (UE), comprising:
receiving, from a network:
a synchronization signal block (SSB)-based measurement timing configuration (SMTC) for a target serving cell, the SMTC indicating an SMTC periodicity for the target serving cell; and
an SSB periodicity of SSBs on the target serving cell;
using the SMTC periodicity and the SSB periodicity to determine a detection and measurement periodicity for the target serving cell; and
performing detection of the target serving cell and measurement of the target serving cell according to the detection and measurement periodicity for the target serving cell.

8. The method of claim 7, wherein using the SMTC periodicity and the SSB periodicity to determine the detection and measurement periodicity for the target serving cell comprises:
determining a minimum of the SMTC periodicity and the SSB periodicity; and
setting the detection and measurement periodicity for the target serving cell equal to the minimum of the SMTC periodicity and the SSB periodicity.

9. The method of claim 7, wherein using the SMTC periodicity and the SSB periodicity to determine the detection and measurement periodicity for the target serving cell comprises:
determining a minimum of the SMTC periodicity and the SSB periodicity;
comparing the minimum of the SMTC periodicity and the SSB periodicity to a lower boundary value for the detection and measurement periodicity; and
performing one of:
setting the detection and measurement periodicity for the target serving cell equal to the minimum of the SMTC periodicity and the SSB periodicity when the minimum of the SMTC periodicity and the SSB periodicity is greater than or equal to the lower boundary value; and
setting the detection and measurement periodicity for the target serving cell equal to the lower boundary value when the minimum of the SMTC periodicity and the SSB periodicity is less than the lower boundary value.

10. The method of claim 9, further comprising receiving, from the network, the lower boundary value for the detection and measurement periodicity.

11. The method of claim 7, wherein the detection of the target serving cell and the measurement of the target serving cell are performed using one or more detection and measurement windows of a detection and measurement window duration that is equal to an SMTC duration indicated by the SMTC.

12. The method of claim 7, wherein:
the detection of the target serving cell is performed using one or more detection windows of a detection window duration that is equal to an SMTC duration indicated by the SMTC; and
the measurement of the target serving cell is performed using one or more measurement windows of a measurement window duration that is equal to an SSB duration for the SSBs on the target serving cell.

13. A method of a user equipment (UE), comprising:
receiving, from a network:
a synchronization signal block (SSB)-based measurement timing configuration (SMTC) for a target serving cell; and
an SSB periodicity of SSBs on the target serving cell;
comparing the SSB periodicity to a lower boundary value for a detection and measurement periodicity for the target serving cell;
performing one of:
setting the detection and measurement periodicity for the target serving cell equal to the SSB periodicity when the SSB periodicity is greater than or equal to the lower boundary value; and
setting the detection and measurement periodicity for the target serving cell equal to the lower boundary value when the SSB periodicity is less than the lower boundary value; and
performing detection of the target serving cell and measurement of the target serving cell according to the detection and measurement periodicity for the target serving cell.

14. The method of claim 13, wherein the detection of the target serving cell and the measurement of the target serving cell are performed using one or more detection and measurement windows of a detection and measurement window duration that is equal to an SMTC duration indicated by the SMTC.

15. The method of claim 13, wherein:
the detection of the target serving cell is performed using one or more detection windows of a detection window duration that is equal to an SMTC duration indicated by the SMTC; and
the measurement of the target serving cell is performed using one or more measurement windows of a measurement window duration that is equal to an SSB duration for the SSBs on the target serving cell.

16-24. (canceled)
